(19) United States
(12) Patent Application Publication
(10) Pub. No.: US 2007/0140457 A1
(43) Pub. Date: Jun. 21, 2007

(54) Method and apparatus for selectively routing callers to service call centers

(75) Inventors: Susanne Crockett, Buffalo Grove, IL (US); Kevin Harber, Pleasanton, CA (US); Rob Lasken, Schaumburg, IL (US); Tina Ramirez, McKinney, TX (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/313,194

(22) Filed: Dec. 19, 2005

(51) Int. Cl. H04M 3/42

(52) U.S. Cl. 379/207.15

(57) ABSTRACT

An apparatus and method are disclosed for selectively routing callers to service call centers. An apparatus that incorporates teachings of the present disclosure may include, for example, a call management center (CMC) (102) having a controller (104). The controller can be programmed to store for each of a plurality of network elements (103) its location, store for each of a plurality of service call centers (112) its location, detect (208) an incoming call originated by a communication device (108, 110), and determine (212) if the communication device is capable of roaming from signaling information associated with the incoming call, identify (214) according to the signaling information a network element near to where the incoming call was originated, determine (216) an approximate location of the communication device according to a location of the identified network element, select (222) a service call center nearest to the approximate location of the communication device, and route (224) the incoming call to the selected service call center. Additional embodiments are disclosed.

### FIELD OF THE DISCLOSURE

The present disclosure relates generally to call routing techniques, and more specifically to a method for selective routing to service call centers.

### BACKGROUND

Toll-free service call center providers often have geographically dispersed service call centers to manage their service over a wide area such as a city, state, or nation. It is generally desirable that a service call center nearest to a calling party process incoming calls from said party. Today service call center providers route calls according to an automatic number identification (ANI) included in the incoming call. From the ANI, a caller ID can be identified which can be used to approximate the caller's location and thereby route the call to the nearest call center.

This location identification process, however, can be ineffective for mobile phone users. When a mobile phone user makes a call to a toll-free number there is no guarantee that the end user will be at a location associated with the caller ID. Accordingly, the caller may be routed to a service call center far from the location of the caller which would be undesirable.

A need therefore arises for a method to selectively route callers to service call centers.

### BRIEF DESCRIPTION OF THE DRAWINGS

FIG. 1 depicts an exemplary embodiment of a call management center (CMC) operating in a communication system;

FIG. 2 depicts an exemplary method operating in the CMC; and

FIG. 3 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method for selectively routing callers to service call centers.

In a first embodiment of the present disclosure, a call management center (CMC) has a controller for managing operations of a plurality of network elements. The controller can be programmed to store for each of the plurality of network elements its location, store for each of a plurality of service call centers its location, detect an incoming call originated by a communication device from a select one of the plurality of network elements, and determine if the communication device is capable of roaming from signaling information associated with the incoming call. If the communication device is capable of roaming, the controller can be programmed to identify from the plurality of network elements according to the signaling information a network element near to where the incoming call was originated, determine an approximate location of the communication device according to a location of the identified network element, select a service call center nearest to the approximate location of the communication device from the plurality of service call center locations, and route the incoming call to the selected service call center.

In a second embodiment of the present disclosure, a computer-readable storage medium operates in a call management center (CMC). The storage medium can have computer instructions for determining if a communication device is capable of roaming from signaling information associated with the incoming call. If the communication device is capable of roaming, the storage medium can include computer instructions for determining an approximate location of the communication device according to a jurisdiction information parameter (JIP) included in the signaling information, selecting from the plurality of service call centers a service call center nearest to the communication device according to the identified service call center provider and the approximate location of the communication device, and routing the incoming call to the selected service call center.

In a third embodiment of the present disclosure, a method operates in a service control point (SCP). The method includes the steps of detecting an incoming call originated by a communication device from a select one of a plurality of network elements, and determining if the communication device is capable of roaming by detecting in a portion of an Originating Line Information Parameter (OLIP) included in signaling information associated with the incoming call any one of the numbers 61, 62 and 63. If the communication device is capable of roaming, the method can further include the steps of identifying from the plurality of network elements according to a jurisdiction information parameter (JIP) included in the signaling information a network element near to where the incoming call was originated, determining an approximate location of the communication device according to a location of the identified network element, selecting a service call center nearest to the approximate location of the communication device from a plurality of service call center locations, and routing the incoming call to the selected service call center.

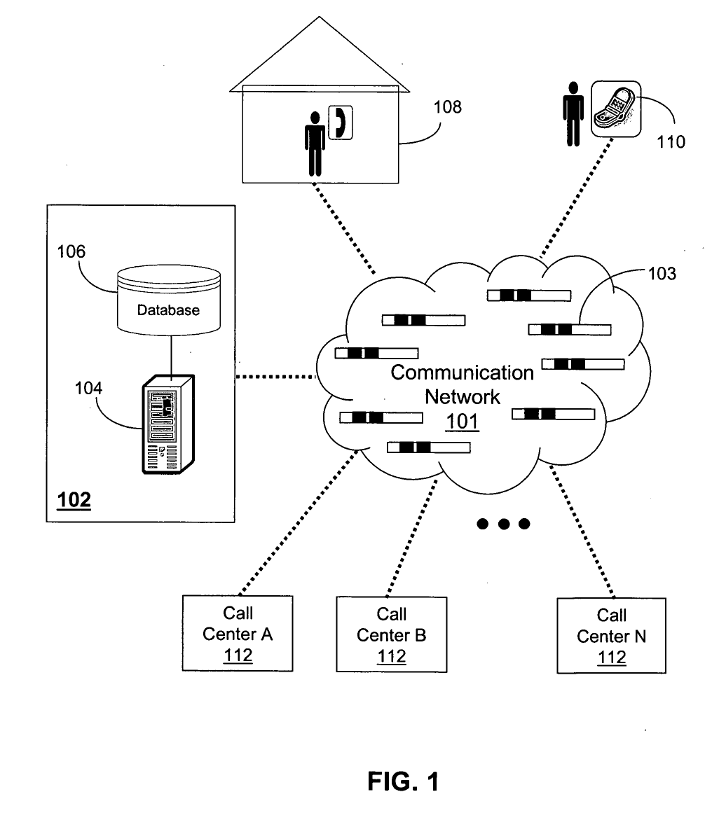

FIG. 1 depicts an exemplary embodiment of a call management center (CMC) 102 operating in a communication system 100. The CMC 102 comprises a database 106 and a controller 104 for managing operations thereof. The controller 104 utilizes wired or wireless communications technology for interfacing to the communication network 101. The communication technology can support common circuit-switched and/or a packet-switched communications. The controller 104 can further include computing technology such as a server that can be scaled according to the computing resources demanded by the present disclosure. The database 106 can operate in common mass storage media devices such as high capacity disk drives.

The CMC 102 can be programmed to manage network elements 103 of the communication network 101. Accordingly, the CMC 102 can be represented by a service control point (SCP) in whole or in part that is capable of intercepting and routing incoming calls to any one of a number of service call centers 112. A network element 103 in the present context can mean a cellular base station or common local and/or long-distance network switches. From a combination of network elements 103 the communication network 101 can support a hybrid of cellular communications (e.g., CDMA, GSM, UMTS, TDMA, and so on) and wired PSTN (Public Switched Telephone Network) communications. For establishing and terminating calls, a number of the network elements 103 exchange signaling information with the CMC 102 in conformance with the well known Signaling System 7 (SS7) protocol.

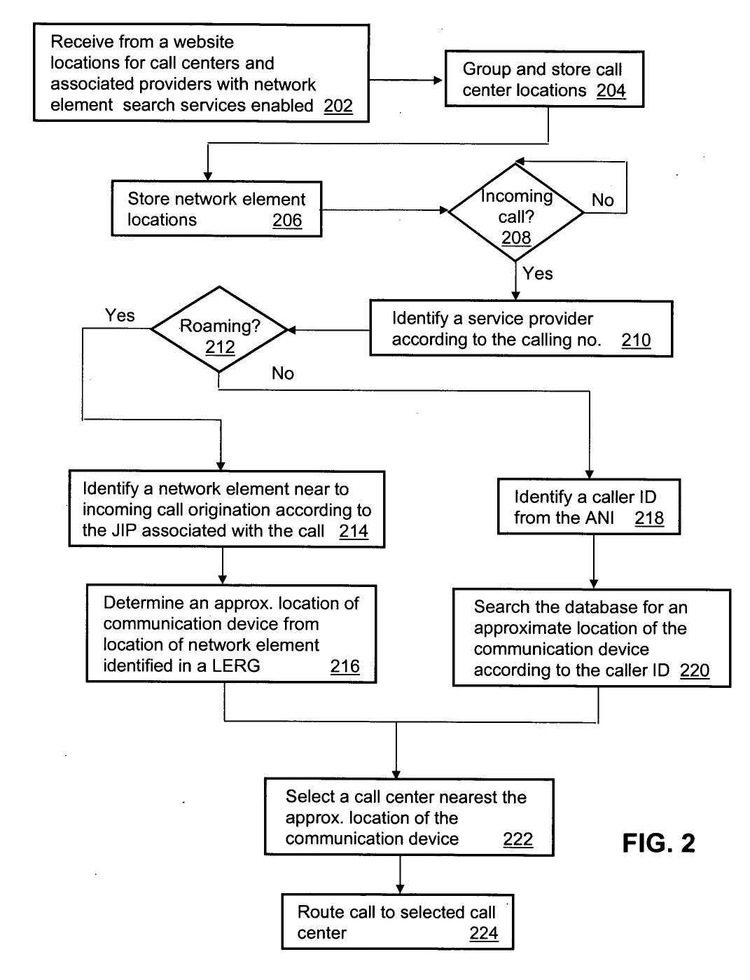

FIG. 2 depicts an exemplary method 200 operating in the CMC 102. Method 200 begins with step 202 where the controller 104 can be programmed to receive from a website hosted by the CMC 102 location information and an associated service call center provider for each of the service call centers 112. In addition, a request can be received from the website to selectively enable or disable network element search services by way of a jurisdiction information parameter (JIP) for routing calls to a nearest service call center 112 as will be described shortly in steps 208-224. The foregoing provisioning parameters can be entered by personnel managing the service call centers by manual or automated means. The location identified for each service call center 112 can represent a geographic footprint that defines a service area managed by the service call center 112. The footprint can be a municipality, a city, a state or a geographic region (e.g., Northeast corridor). Each service call center 112 is managed by an associated service call center provider and can be manned by agents and/or an interactive voice response system (IVR) for processing calls. It should be noted that a service call center provider as referred to herein can be an enterprise that operates independently from a service provider managing the communication network 101.

Step 202 also allows each service call center provider to enable or disable network element 112 search services for roaming callers as will be described shortly. In step 204, the controller 104 can be further programmed to logically group and store in the database 106 the service call locations according to the associated service call center providers. In step 206, the controller 104 can be programmed to store locations for each of the network elements 103 of the communication network 101. The locations of the network elements 103 can similarly be stored in the database 106.

In step 208, the controller 104 monitors incoming calls from callers 108 or 110 coupled to the communication network 101 by way of the network elements 103. If an incoming call is detected, the controller 104 proceeds to step 210 where it identifies a service call center provider from the database 106 according to a calling number retrieved from a portion of an automatic number identification (ANI) included in SS7 signaling information received with the incoming call. This portion of the ANI can be represented by the NPA-NXX-XXXX (i.e., the 10 digit calling number). Step 208 and the steps that follow are executed by the controller 104 only if the provisioning information provided in step 202 calls for routing calls according to the JIP. Thus, in step 202 routing of calls according to the JIP can be enabled or disabled for each calling number (e.g., a toll-free number) associated with the service call centers 112. The process for enabling or disabling JIP routing for each of the calling numbers can be accomplished by checking off or toggling a button presented by a graphical user interface (GUI) of the website.

In step 212, the controller 104 further determines if the communication device originating the incoming call is capable of roaming. This information can be determined from an Originating Line Information Parameter (OLIP) included in the SS7. The OLIP is also referred to as an ANI II code which has two digits ranging from 00 through 99. If the ANI II digits are 61 (PCS Type 1), 62 (PCS Type 2) or 63 (PCS roaming), the controller 104 can determine therefrom that the incoming call originated from a mobile communication device such as communication device 110 illustrated in FIG. 1. In this instance, the caller ID retrieved from the ANI would not be useful in identifying the location of communication device 110 since the end user of said device may be roaming anywhere within the coverage range of the communication network 101.

Accordingly, when the controller 104 detects a roaming communication device 110, it proceeds to step 214 where it identifies a network element 103 near to where the incoming call was originated from a portion of the signaling information referred to as JIP. The JIP provides an NPA-NXX that identifies the network element 103 nearest to a location where the incoming call originated. The network element 103 identified can be a switch closest to the base station receiving the incoming call. Once the network element 103 has been identified, the controller 104 proceeds to step 216 where it determines an approximate location of the communication device 110 from a location of the network element 103 as identified in a local exchange routing guide (LERG).

The approximate location of the communication device 110 may be a geographic footprint associated with the identified network element 103. From step 216, the controller 104 proceeds to step 222 where it selects a call center 112 from its database 106 nearest to the communication device 110 according to the identified service call center provider and the approximate location of the communication device 110. Thus, the controller 104 attempts to match the geographic footprint of the communication device 110 (derived from the footprint of the network element 103) to the nearest geographic footprint of the service call centers 112. Once the nearest service call center 112 has been identified, the controller 104 proceeds to step 224 where it routes the incoming call to the selected service call center 112.

The foregoing steps occur prior to any interaction with the service call centers 112. That is, the first interaction between a service call center 112 and the calling party associated with the incoming call takes place at the nearest point between the parties. Accordingly, there is no need for an agent or automated controller in a service call center 112 intercepting the call to route the call to another service call center because another service call center is found to be closer to the calling party. The agent may reroute the call to another service call center for reasons unrelated to proximity such as, for example, routing the caller to another center 112 having a particular expertise unavailable in her center to best serve the caller's needs.

Referring back to step 212, if the controller 104 detects that the incoming call is not associated with a roaming communication device (such as a residential communication device 108 shown in FIG. 1), the controller 104 proceeds to step 218 where it identifies a caller ID from a portion of the ANI. In step 220, the controller 104 searches its database 106 for an approximate location of the communication device 108 according to the caller ID. The location of the communication device 108 can be a residential address of the calling party retrieved from account records associated with the communication service provided to said party, or simply an area associated with the exchange portion of the caller ID (e.g., a city). From step 220, the controller 104 performs steps 222-224 where it selects the nearest service call center 112 to the identified residence or city, and routes the call to the selected service call center 112.

The aforementioned descriptions of method 300 provides for a single step routing transaction to a service call center 112 nearest to the communication device 108 or 110 originating the call. Method 300 can be applied to any number of service call center transactions. For example, method 300 can be used for present and future generations of toll-free service calls, information service calls (e.g., 411 and XXX-555-1212 calls), emergency service calls, and billable service calls (e.g., 900-XXX-XXXX).

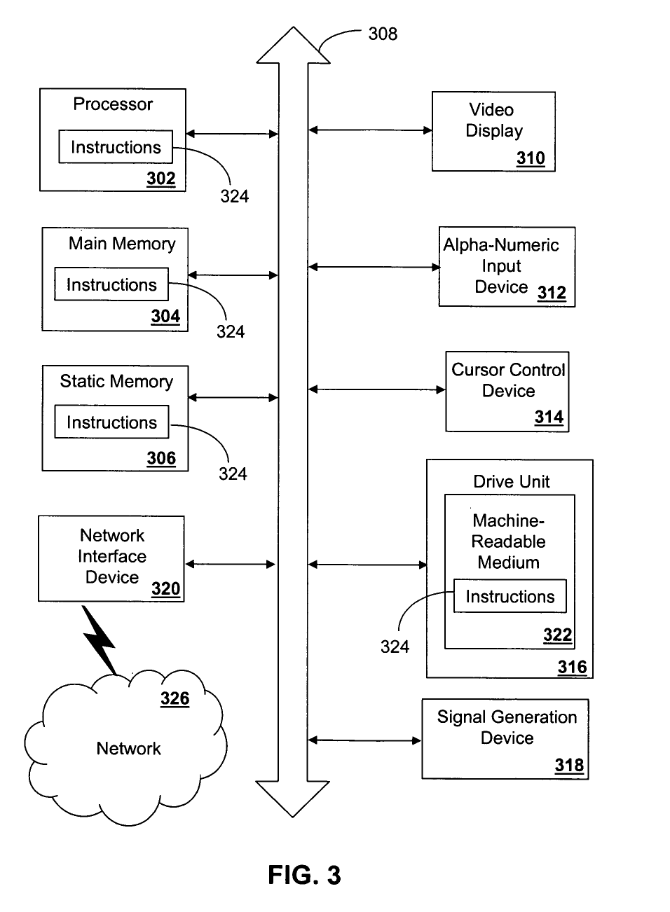

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example. embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A call management center (CMC), comprising:
a controller for managing operations of a plurality of network elements, programmed to:
store for each of the plurality of network elements its location;
store for each of a plurality of service call centers its location;
detect an incoming call originated by a communication device from a select one of the plurality of network elements;
determine if the communication device is capable of roaming from signaling information associated with the incoming call;
if the communication device is capable of roaming,
identify from the plurality of network elements according to the signaling information a network element near to where the incoming call was originated;
determine an approximate location of the communication device according to a location of the identified network element;
select a service call center nearest to the approximate location of the communication device from the plurality of service call center locations; and
route the incoming call to the selected service call center.

2. The CMC of claim 1, wherein the controller is programmed to determine if the communication device is capable of roaming according to a portion of an Originating Line Information Parameter (OLIP) included in the signaling information.

3. The CMC of claim 2, wherein the controller is programmed to determine if the communication device is capable of roaming by detecting in the portion of the OLIP any one of the numbers 61, 62 and 63.

4. The CMC of claim 1, wherein the signaling information comprises a jurisdiction information parameter (JIP) for identifying the network element nearest to a location where the incoming call originated.

5. The CMC of claim 4, wherein the JIP comprises an area code and exchange code associated with the network element.

6. The CMC of claim 1, wherein the signaling information conforms to a Signaling System 7 (SS7) protocol.

7. A computer-readable storage medium operating in a call management center (CMC), comprising computer instructions for:
determining if a communication device is capable of roaming from signaling information associated with the incoming call;
if the communication device is capable of roaming, determining an approximate location of the communication device according to a jurisdiction information parameter (JIP) included in the signaling information;
selecting from the plurality of service call centers a service call center nearest to the communication device according to the identified service call center provider and the approximate location of the communication device; and
routing the incoming call to the selected service call center.

8. The storage medium of claim 7, comprising computer instructions for determining if the communication device is capable of roaming by detecting in a portion of an Originating Line Information Parameter (OLIP) included in the signaling information any one of the numbers 61, 62 and 63.

9. The storage medium of claim 7, wherein the JIP comprises an area code and exchange code associated with the network element.

10. The storage medium of claim 7, comprising computer instructions for receiving the location and associated service call center provider for each of the plurality of service call centers from a website hosted by the CMC with a request to enable network element search services.

11. The storage medium of claim 7, wherein the incoming call comprises one among a toll-free service call, an information service call, an emergency service call, and a billable service call.

12. The storage medium of claim 7, wherein the CMC comprises a service control point (SCP) for intercepting incoming calls and routing said calls according to the foregoing steps.

13. The storage medium of claim 7, comprising computer instructions for determining the approximate location of the communication device according to a portion of an automatic number identification (ANI) included in the signaling information if the communication device is not capable of roaming.

14. A method in a service control point (SCP), comprising:
detecting an incoming call originated by a communication device from a select one of a plurality of network elements;
determining if the communication device is capable of roaming by detecting in a portion of an Originating Line Information Parameter (OLIP) included in signaling information associated with the incoming call any one of the numbers 61, 62 and 63;
if the communication device is capable of roaming,
identifying from the plurality of network elements according to a jurisdiction information parameter (JIP) included in the signaling information a network element near to where the incoming call was originated;
determining an approximate location of the communication device according to a location of the identified network element;
selecting a service call center nearest to the approximate location of the communication device from a plurality of service call center locations; and
routing the incoming call to the selected service call center.

15. The method of claim 14, comprising the step of determining the approximate location of the communication device according to an automatic number identification (ANI) if the communication device is not capable of roaming.

16. The method of claim 15, comprising the steps of:
identifying a caller ID in the portion of the ANI; and
searching in a database the approximate location of the communication device according to the caller ID.

17. The method of claim 14, comprising the steps of:
presenting a graphical user interface (GUI) of a website application for provisioning the SCP;
receiving from the website the plurality service call center locations with associated service call center providers and a request to enable network element search services;
grouping the service call center location by their associated service call center provider; and
storing the groupings of service call center locations.

18. The method of claim 17, comprising the step of:
identifying a service call center provider according to a calling number including in the signaling information; and
determining the service call center according to the approximate location of the communication device and the identified service call center provider

19. The method of claim 14, comprising the step of determining the location of the identified network element from a local exchange routing guide (LERG) according to the JIP.

20. The method of claim 14, wherein the JIP comprises a numbering plan area (NPA) and a numeric numbering exchange (NXX) associated with the identified network element.
